(19) United States
(12) Patent Application Publication
(10) Pub. No.: US 2026/0261454 A1
(43) Pub. Date: Sep. 3, 2026

(54) INDICATION OF CHANNEL STATE INFORMATION REFERENCE SIGNAL PATTERN FOR MACHINE LEARNING-ASSISTED CHANNEL STATE INFORMATION SCHEMES

(71) Applicant: QUALCOMM Incorporated, San Diego, CA (US)

(72) Inventors: Rui HU, Beijing (CN); Chenxi HAO, Beijing (CN); Wei XI, Beijing (CN); Taesang YOO, San Diego, CA (US); Hao XU, Beijing (CN); Yu ZHANG, San Diego, CA (US); Liangming WU, Beijing (CN); Yuwei REN, Beijing (CN); June NAMGOONG, San Diego, CA (US)

(21) Appl. No.: 18/869,752

(22) PCT Filed: Jul. 19, 2022
(86) PCT No.: PCT/CN2022/106391

§ 371 Date: Nov. 26, 2024

(51) Int. Cl. H04L 25/02; H04L 5/00; H04W 24/10

(52) U.S. Cl. CPC H04L 25/0224; H04L 5/0051; H04W 24/10

(57) ABSTRACT

Certain aspects of the present disclosure provide a method of wireless communications by a user equipment (UE), generally including receiving signaling, from a network entity, indicating at least a first channel state information (CSI) reference signal (CSI-RS) pattern indicating CSI-RS resources, wherein the first CSI-RS pattern indicates a lower density of CSI-RS resources in a channel frequency range, than a second CSI-RS pattern; updating a machine learning (ML) model based on the first CSI-RS pattern; generating, using the updated ML model, CSI for the channel frequency range based on measurements taken by the UE according to the first CSI-RS pattern; and transmitting a report to the network entity indicating the CSI for the channel frequency range.

### BACKGROUND

### Field of the Disclosure

Aspects of the present disclosure relate to wireless communications, and more particularly, to techniques for channel state information (CSI) measurement and reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving signaling, from a network entity, indicating at least a first channel state information (CSI) reference signal (CSI-RS) pattern indicating CSI-RS resources, wherein the first CSI-RS pattern indicates a lower density of CSI-RS resources in a channel frequency range, than a second CSI-RS pattern; updating a machine learning (ML) model based on the first CSI-RS pattern; generating, using the updated ML model, CSI for the channel frequency range based on measurements taken by the UE according to the first CSI-RS pattern; and transmitting a report to the network entity indicating the CSI for the channel frequency range.

Another aspect provides a method of wireless communications by a network entity. The method includes transmitting signaling indicating, to a UE, at least a first CSI-RS pattern indicating CSI-RS resources, wherein the first CSI-RS pattern indicates a lower density of CSI-RS resources, in a channel frequency range, than a second CSI-RS pattern; transmitting CSI-RS according to the first CSI-RS pattern; and receiving a report indicating CSI, generated by the UE based on the CSI-RS, for the channel frequency range.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of a machine learning (ML) based channel state information (CSI) measurement and reporting scheme.

FIG. 6 is a call flow diagram for an ML based CSI measurement and reporting scheme, in accordance with aspects of the present disclosure.

FIG. 7 depicts an example low density CSI-RS pattern, in accordance with aspects of the present disclosure.

FIG. 8 depicts an example CSI-RS configuration with full density and low density CSI-RS configured in a same resource set, in accordance with aspects of the present disclosure.

FIG. 9 depicts an example ML based CSI measurement and reporting scheme, in accordance with aspects of the present disclosure.

FIG. 10 depicts an example showing how an ML based CSI measurement and reporting scheme based on low density CSI-RS can be used to recover a full channel, in accordance with aspects of the present disclosure.

FIG. 11 depicts an example of potential overhead reduction achievable using an ML based CSI measurement and reporting scheme, in accordance with aspects of the present disclosure.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and non-transitory computer-readable mediums for machine learning (ML) based channel estimation.

In current wireless communication systems, channel state information (CSI) reporting allows a UE to measure the quality of a variety of radio channels and report the results to a network entity. In some cases, CSI compression may be utilized to limit signaling overhead. In such cases, some linear combination of spatial, frequency, and time domain as a basis may be used to perform channel compression and information extrapolation based on UE observations. A UE may report channel measurement values extrapolated from actual observed CSI measurements of CSI reference signals (CSI-RS).

In some cases, resource reduction along the spatial dimension may be achieved using a non-orthogonal cover code, while reduction along the frequency dimension may be achieved using a low-density CSI-RS pattern. For example, the low density CSI-RS pattern may include relatively sparse resources allocated for CSI-RS transmissions, with only a relatively small fraction of available resource blocks (RBs) used for CSI-RS transmissions.

In certain ML models used for CSI measurement and reporting, a UE and network entity (e.g., gNB) may collaborate by sharing assistance information. For example, in one form of collaboration, inter-node assistance may help improve the respective nodes of an ML based algorithm. This may apply to UEs receiving assistance information from gNBs (e.g., for training, adaptation, etc.), as well as UEs receiving assistance information from gNBs. In some cases, assistance information may be exchanged without exchanging information about the actual ML models. In other cases (e.g., for joint ML operation), a UE and gNB may exchange information regarding ML models or ML model instruction.

ML based CSI schemes involving low-density CSI-RS patterns are examples of scenarios where information may be exchanged between a UE and gNB. For example, due to an association between low-density CSI-RS patterns and a UE channel estimation (CHEST) ML model. In some cases, a CHEST ML model may need to be changed. For example, when the environment changes, the CSI-RS pattern may be changed. In such cases, the UE may need assistance information from the gNB for training, adaptation, and the like.

Aspects of the present disclosure provide various mechanisms for providing such assistance information, for example, indicating a new low-density CSI-RS pattern. The signaling mechanisms may help update an ML model used for CSI measurement and reporting, for example, allowing for additional training of a current ML model or selection of a new ML model. In some cases, both full-density and low-density CSI-RS patterns may be used, with different low-density CSI-RS patterns dynamically indicated for model training purposes. Full-density CSI-RS patterns may be used as real word data used to train and test the ML model outputs (referred to as ground truth). For example, in training, a loss function may be obtained comparing model output to a ground-truth estimated channel obtained by using the full-density CSI-RS pattern.

The signaling mechanisms provided herein may help ensure that the mismatch between CSI generated based on the full-density CSI-RS and CSI generated based on low-density CSI-RS is negligible. The ability to efficiently indicate updated CSI-RS patterns as proposed herein may lead to improved accuracy of the ML model, improved system performance, and improved overall user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

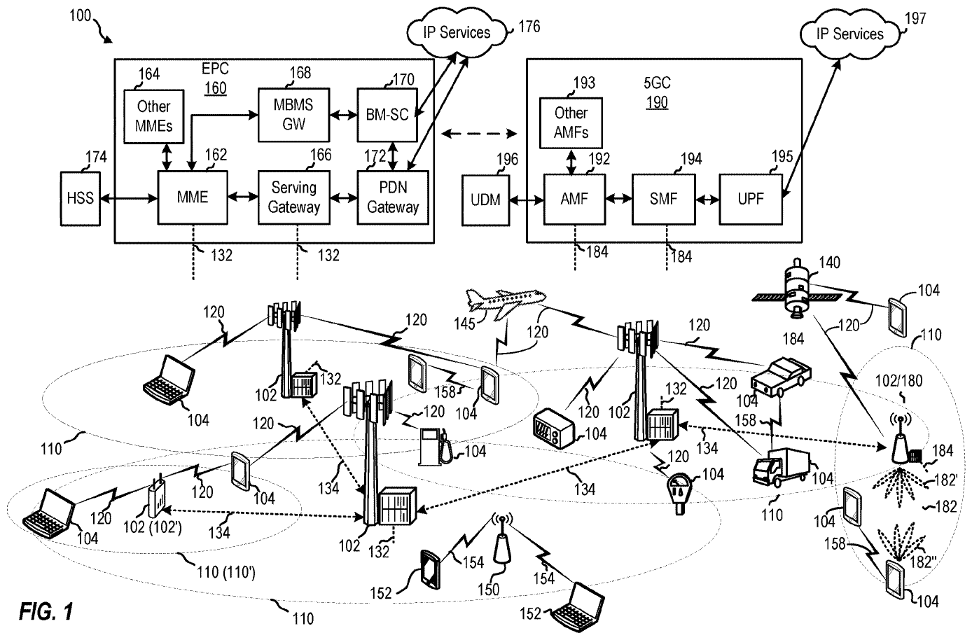

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. As a result, references to a network entity within the present disclosure may refer to a base station (e.g., a g_NB) or a node of a disaggregated base station. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture.

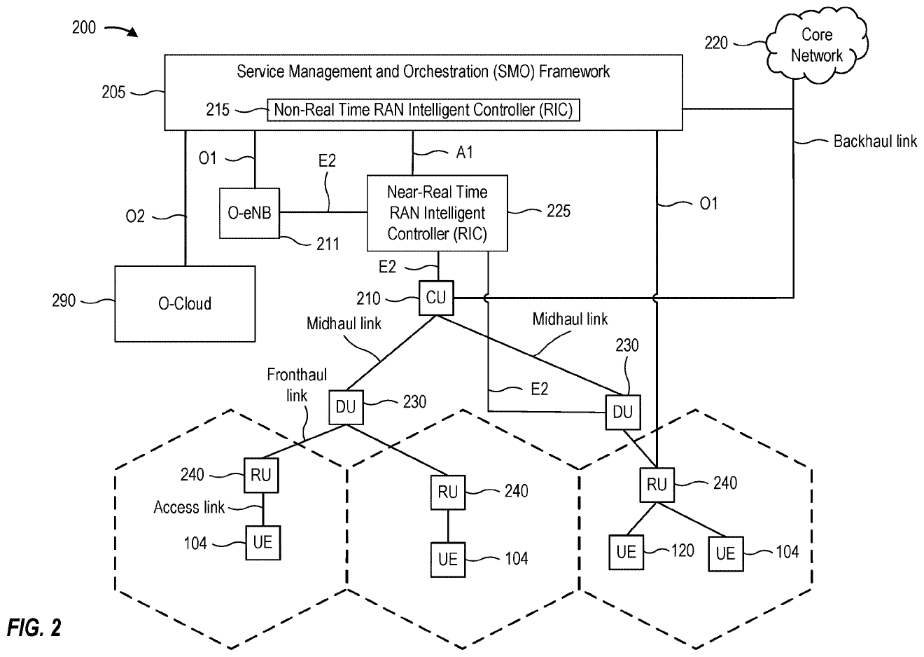

FIG. 2 depicts and describes an example disaggregated base station architecture. Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz−7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

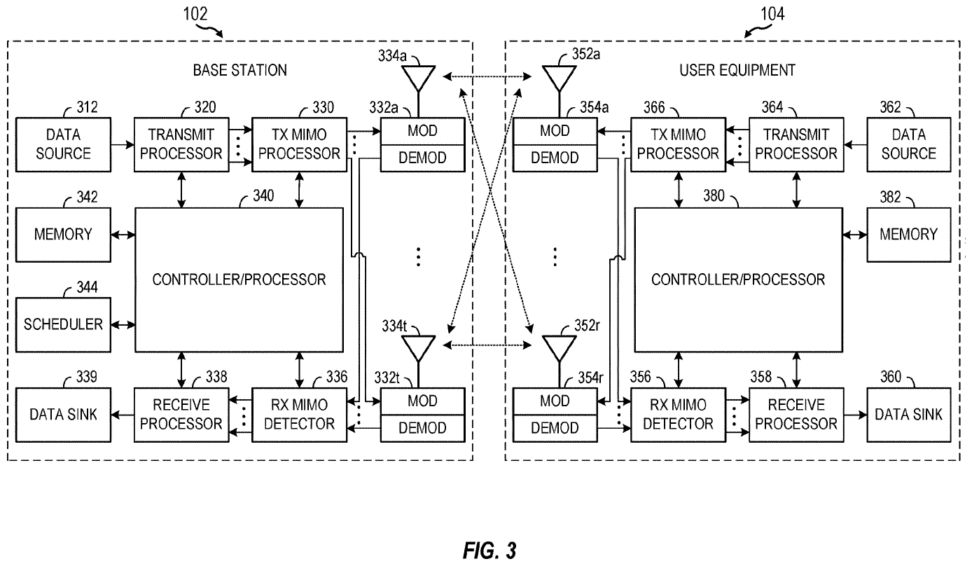

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

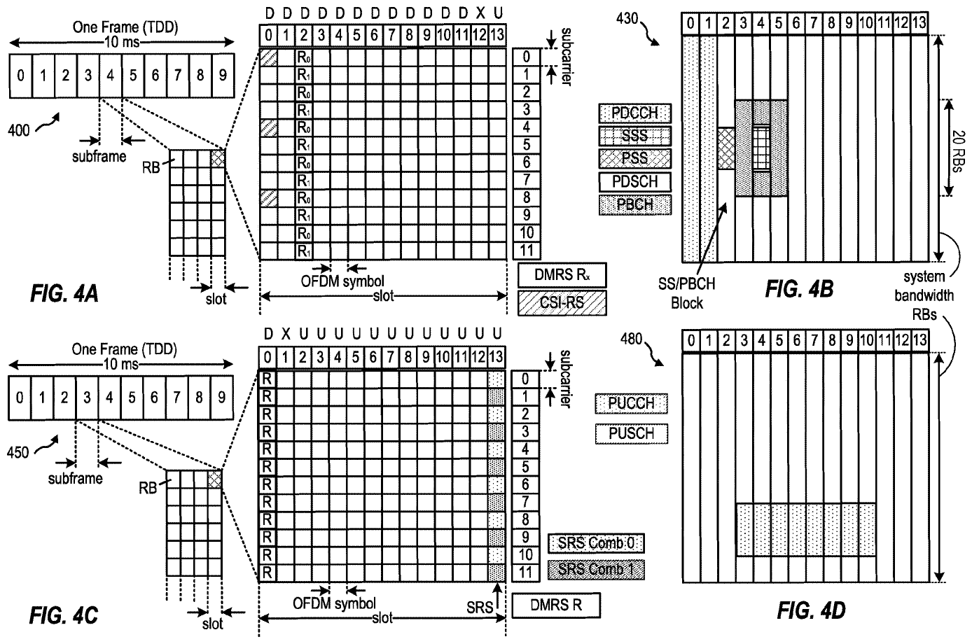

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of ML-Based CSI Measurement and Reporting

CSI reporting allows a UE to measure the quality of a variety of radio channels and report the results to a network entity. Some advanced CSI schemes utilize machine learning (ML) models, such as neural network (NN)-based CSI schemes, with reduced CSI-RS consumption (consuming fewer time and frequency resources for CSI-RS transmissions). Despite reduced CSI-RS overhead, the UE may be able to recover (estimate) the full channel, using the ML model.

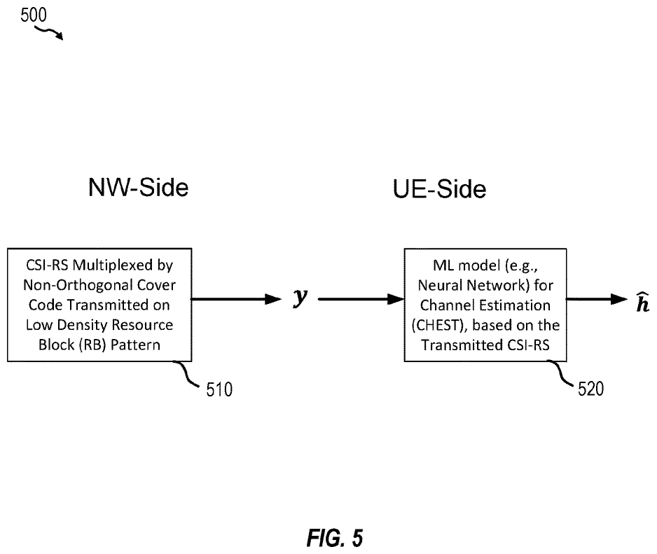

As illustrated in diagram 500 FIG. 5, in some cases, reduced CSI-RS consumption may come from reductions in the spatial dimension and frequency dimension. Reductions along the spatial dimension may be based on the multiplexing of CSI-RS by a non-orthogonal cover code (at block 510) on a low density RB pattern. In some cases, the non-orthogonal cover code can be learned together with the channel estimation (CHEST) ML model.

Reduction along the frequency dimension may be based on the low-density resource block (RB) pattern. For example, K RBs out of N RBs (K<N) may be selected to transmit CSI-RS. In such cases, the pattern could be a uniform RB pattern, a random RB pattern, or a learned RB pattern (e.g., some form of pattern may be used specifically for certain scenarios).

Non-orthogonal cover codes may be used to multiplex Nₜ CSI-RS ports onto L resource elements (REs) within an RB, where L<Nₜ. The UE may use an ML model associated with the low-density CSI-RS pattern to recover the channel matrix h.

In some cases, CSI compression may be utilized to limit signaling overhead. In such cases, some linear combination of spatial, frequency, and time domain as a basis may be used to perform channel compression and information extrapolation based on UE observations. A UE may report channel measurement values extrapolated from actual observed CSI measurements of CSI reference signals (CSI-RS).

In some cases, resource reduction along the spatial dimension may be achieved using a non-orthogonal cover code, while reduction along the frequency dimension may be achieved using a low-density CSI-RS pattern. For example, the low density CSI-RS pattern may include relatively sparse resources allocated for CSI-RS transmissions, with only a relatively small fraction of available resource blocks (RBs) used for CSI-RS transmissions.

Different ML based CHEST schemes involve different levels of collaboration between the UE and network entity (e.g., gNB. In a first level of collaboration, ML algorithms may be purely implementation specific (e.g., at the UE or gNB) without a need to make a change to a standard specification. In a second level of collaboration, the exchange of information between nodes (inter-node assistance between a UE and gNB) may help improve a respective node's ML algorithm. This level may apply to UEs receiving assistance from gNBs (e.g., for model training and/or adaptation, etc.) or to gNBs receiving assistance from UEs. A third level of collaboration may involve joint ML operation between UEs and gNBs. This level may involve ML model instruction or exchange between network nodes.

### Aspects Related to Indicating CSI-RS Patterns for ML-Assisted CSI Schemes

ML based CSI schemes involving low-density CSI-RS patterns are examples of scenarios where information may be exchanged between a UE and gNB. For example, there may be an association between low-density CSI-RS patterns and a UE channel estimation (CHEST) ML model. In some cases, a CHEST ML model may need to be changed. For example, when the environment changes, the CSI-RS pattern may be changed. In such cases, the UE may need assistance information from the gNB for training, adaptation, and the like.

Aspects of the present disclosure provide various mechanisms for indicating new low-density CSI-RS patterns. For example, the signaling may indicate a subset of (K) RBs, selected from a larger set of (N) RBs. In some cases, the indicated low-density RB pattern can be fixed and may be associated with a cover code. For example, there may be a pre-defined set of non-orthogonal cover codes, and each of these non-orthogonal cover codes may be associated with an RB pattern.

As noted above, in some cases, a low-density RB pattern (indicating RBs allocated for CSI-RS transmission) can be dynamically changed. For example, the non-orthogonal cover code can be the same for every RB and a gNB or UE may dynamically select an RB pattern. In some cases, a non-orthogonal cover code may be designed for full bandwidth and each RB may have a different cover code. In such cases, a gNB or UE may select an RB pattern and the cover code may be implicitly determined (based on an associated with the selected RB pattern).

In some cases, different types (densities) of CSI-RS patterns may be used for different purposes. For example, a full-density CSI-RS pattern may be used as real word data used to train and test the ML model outputs (ground truth) for the UE to train a CHEST ML model. A low-density CSI-RS pattern may also be used to train the CHEST ML model. For example, during training a loss function may be based on a minimum mean square error (MMSE) equation as:

$${‖ h - \hat{h} ‖}_{F}^{2} / {‖ h ‖}_{F}^{2} ,$$

where the ground-truth h is the estimated channel obtained by using the full-density CSI-RS pattern (and conventional channel estimation techniques). In other words, in training, a loss function may be obtained comparing model output to a ground-truth estimated channel obtained by using the full-density CSI-RS pattern The indication of these two CSI-RS patterns may be intended to ensure that the mismatch between channel estimation based on the full-density CSI-RS channel estimation and channel estimation based on low-density CSI-RS is negligible.

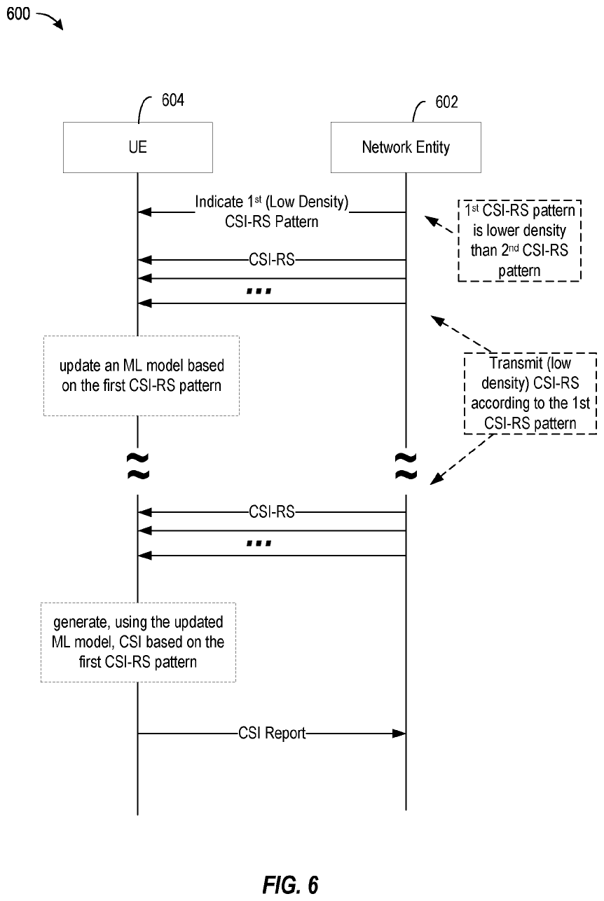

Mechanisms for indicating a new low-density CSI-RS pattern proposed herein may be understood with reference to the call flow diagram 600 of FIG. 6. In certain aspects, network entity 602 may be an example of a base station depicted in FIG. 1 or FIG. 3 or may be an example of a node of the disaggregated base station of FIG. 2. Similarly, UE 604 may be an example of a UE 102 depicted in FIG. 1 or FIG. 3.

As illustrated, the UE may receive signaling, from the network entity, indicating at least a first CSI-RS pattern. The first CSI-RS pattern may indicate time and frequency resources (e.g., RBs and/or REs within an RB) used for CSI-RS transmissions. The first CSI-RS pattern may indicate a lower density of CSI-RS resources in a channel frequency range, than a second (e.g., full-density) CSI-RS pattern.

The UE may update an ML model based on the first CSI-RS pattern. For example, as noted above, during training the UE may apply a loss function by comparing output of the ML model, generated based on measurements taken from CSI-RS transmitted according to the first CSI-RS pattern, to a ground-truth estimated channel obtained by using the full-density CSI-RS pattern. The first CSI-RS pattern may also be used when the UE uses the ML model for channel estimation (e.g., after the ML model is well-trained and ready to use).

For example using the updated ML model, the UE may generate CSI for the channel frequency range based on measurements taken by the UE according to the first CSI-RS pattern. For example, the UE may input measurements taken from CSI-RS transmitted according to the first CSI-RS pattern, to the trained ML model to generate a channel estimate. The UE may then transmit a report to the network entity indicating the CSI for the channel frequency range.

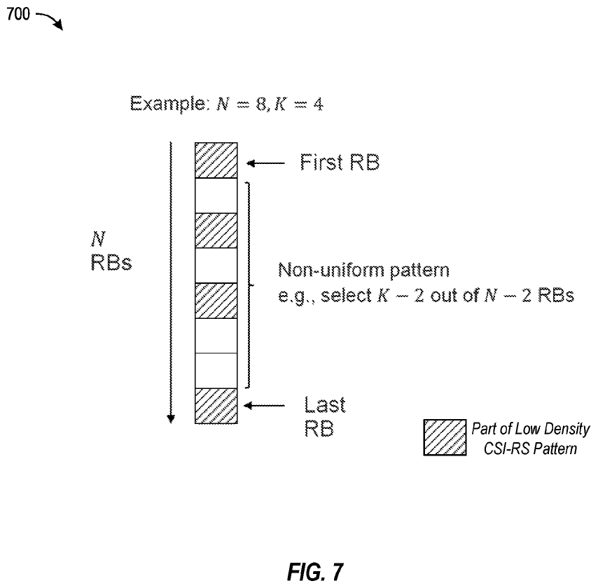

As illustrated in FIG. 7, in some cases, the low density CSI-RS pattern 700 may be a non-uniform RB Pattern. In some cases, to ensure non-uniformity, edge RBs (first and last RBs) may be included as well as additional RBs selected according to an algorithm. For example, assuming the low density pattern has K=4 RBs selected out or N=8 total RBs, in addition to the 2 edge RBs, K-2 RBs may be selected out of the remaining N-2 RBs.

In some cases, the UE may be configured to indicate (via reporting) its accepted RB patterns. This approach may be suitable, for example, for UEs that train their CHEST ML models with specific RB patterns. Various options may be considered for this type of RB pattern reporting. For example, according to a first option, a gNB may pre-configure a set of RB pattern options and the UE may report one or multiple indices of these options. In some cases, rather than a preconfigured set, a function ƒ(index) may be used, where the output of this function is an RB pattern. According to another option, the UE may report an RB pattern explicitly. For example, in such cases, the UE may report actual indices of RBs for a given pattern.

In some cases, a network entity may configure an RB pattern in a CSI-RS resource configuration. In such cases, configured RB patterns may be selected from the UE reported patterns.

In other cases, a network entity may directly configures an RB pattern within a configured CSI-RS resource. For example, this option may be suitable for UEs that train their CHEST ML models on any RB patterns (rather than just a specific few patterns. In this case, the configuration could be indicated explicitly or implicitly. For implicit configuration, for example, there may be a random permutation function ƒ(seed) available at both the network and UE. The RB pattern may then be indicated through a seed value (used by both the network and UE to generate a pattern).

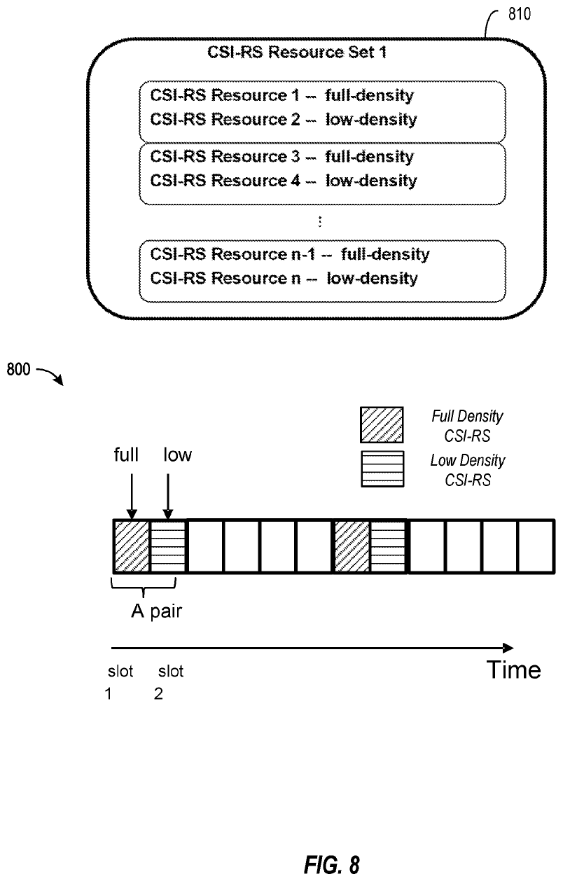

As illustrated in FIG. 8, in some case, the network entity may configure both full-density and low-density CSI-RS patterns within a CSI-RS resource set 810. As illustrated in grid 800, the full-density CSI-RS pattern and low-density CSI-RS pattern may be grouped in pairs. In this manner, the low-density CSI-RS may be referenced to the full-density CSI-RS in each pair. In the illustrated example, CSI-RS is transmitted according to a full density CSI-RS pattern in a first slot (slot 1), while CSI-RS is transmitted according to a low density CSI-RS pattern (of the same pair) in a second slot (slot 2). In this case, the mismatch between the channels on slot 1 and 2 may be negligible, so that the estimated channel obtained from the full-density CSI-RS (in slot 1) can be used as the ground truth.

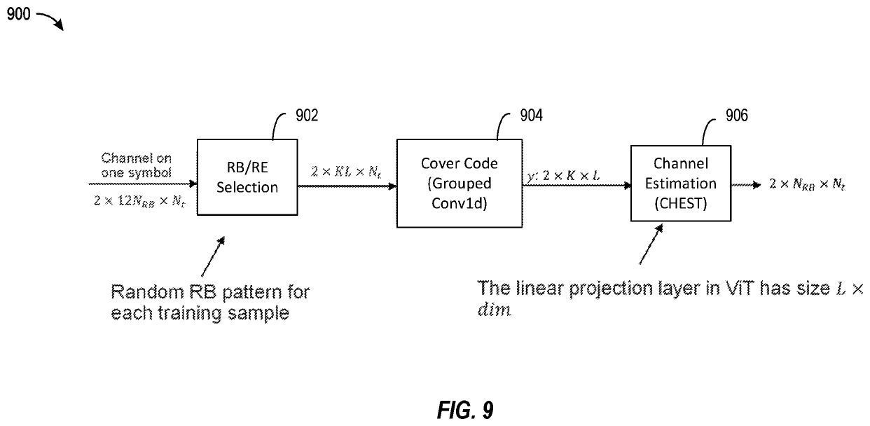

As illustrated in FIG. 9, in some cases, a UE CHEST ML models may be trained with random RB patterns. As noted above, CSI-RS reduction may be achieved in the spatial by multiplexing Nₜ ports on L(L<Nₜ) REs and in the frequency domain by selecting K out of N RBs for CSI-RS (e.g., K=αN_{RB}, where α<1).

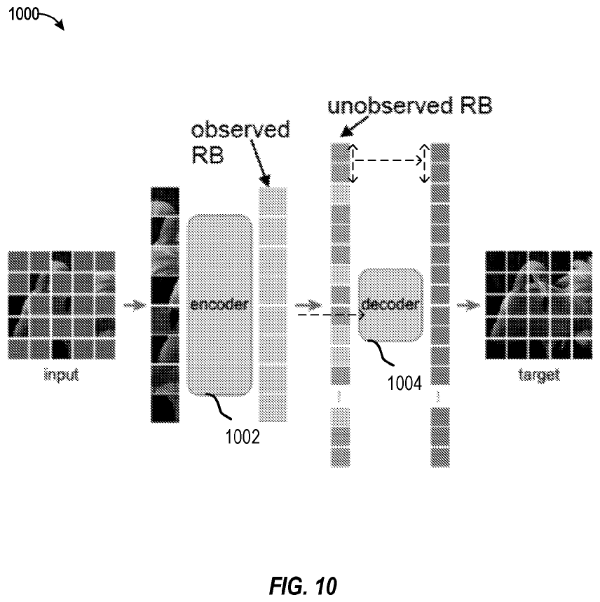

As such, the channel on each RB is a patch, with the input into an encoder being y: 2×K×L. Assuming a total of K patches, each patch has size 1×2 L. The output of the encoder is the full channel: 2×N_{RB}×Nₜ, assuming the ML model for CHEST has a linear projection layer in ViT has size L×dim. In some cases, the ML model may be implemented using a masked auto-encoder (MAE). MAEs have been shown to be suitable as scalable vision learners. As illustrated in FIG. 10, this approach may allow an encoder 1002 to encode an image as a relatively sparse representation on a subset of observed RBs. On the receiver side, a decoder 1004 receiving the observed RBs as input, may use an ML model to recover the full target image, including unobserved RBs.

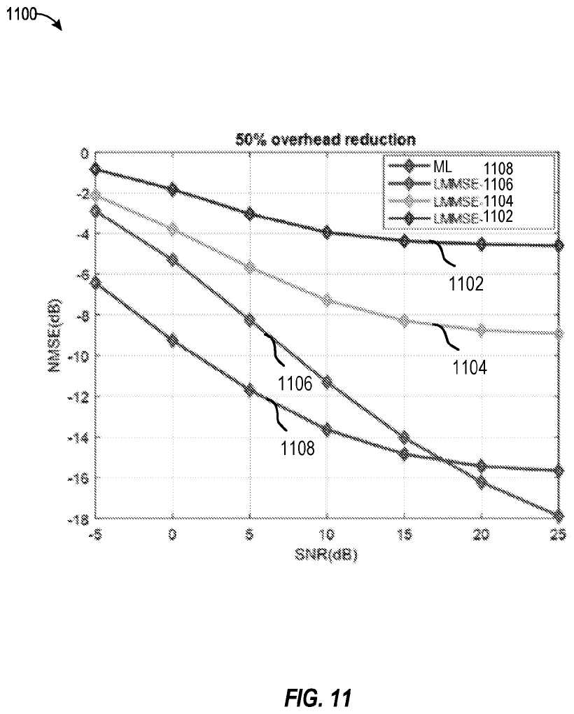

FIG. 11 depicts an example of simulated performance results obtainable using such an ML based CSI measurement and reporting scheme. The examples shown assume 48 RBs available for CSI-RS (N_{RB}=4⁸), 32 CSI-RS ports (Nₜ=32), a random RB pattern for ML model training, and a 50% overhead reduction. As illustrated, for certain SNR (e.g., SNR up to 17 dB) results 1108 obtained using the ML model are better (lower MMSE in terms of dB) than other methods (including results 1102, 1104, and 1106 for various LMMSE-based methods, using a robust power density profile, average channel matrix H, and a genie-aided condition where full CSI is known). At higher SNR (e.g. above 17 dB), results 1106 obtained using the full CSI may be slightly better than the results 1108 obtained using the ML model.

As described herein, the signaling mechanisms proposed may help ensure that the mismatch between CSI generated based on the full-density CSI-RS and CSI generated based on low-density CSI-RS is negligible. The ability to efficiently indicate updated CSI-RS patterns as proposed herein may lead to improved accuracy of the ML model, improved system performance, and improved overall user experience.

### Example Operations of a User Equipment

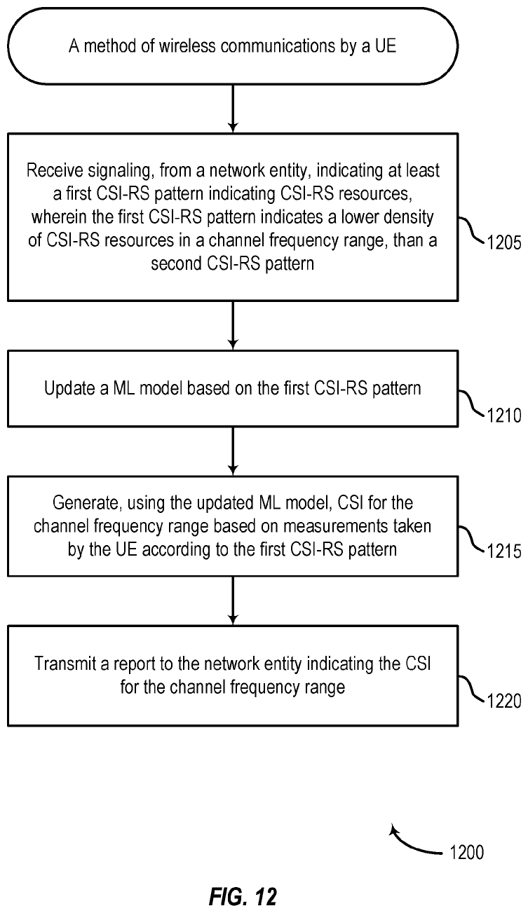

FIG. 12 shows an example of a method 1200 of wireless communications by a UE, such as UE 104 of FIGS. 1 and 3.

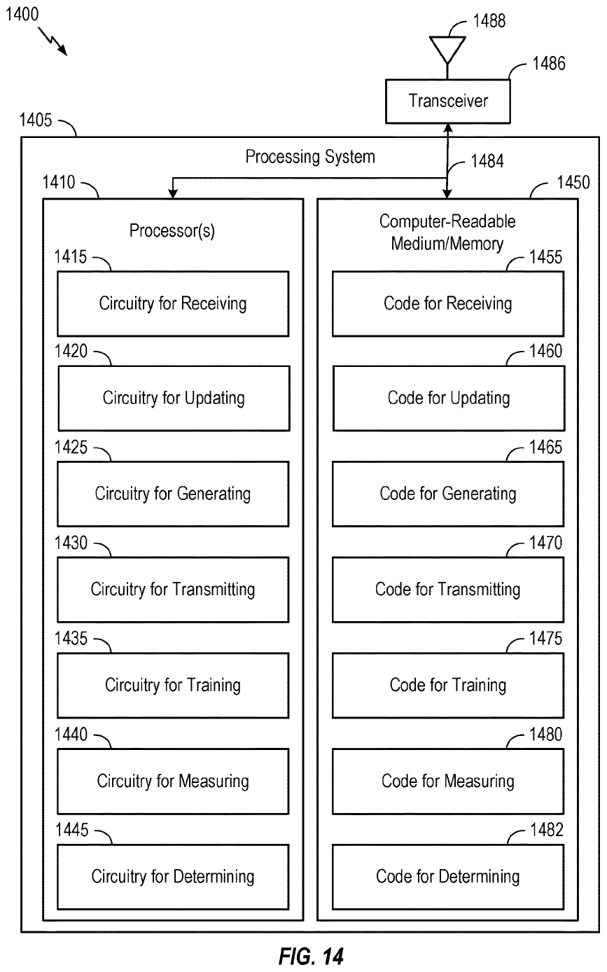

Method 1200 begins at step 1205 with receiving signaling, from a network entity, indicating at least a first CSI-RS pattern indicating CSI-RS resources, wherein the first CSI-RS pattern indicates a lower density of CSI-RS resources in a channel frequency range, than a second CSI-RS pattern. In some cases, the operations of this step refer to, or may be performed by, circuitry for receiving and/or code for receiving as described with reference to FIG. 14.

Method 1200 then proceeds to step 1210 with updating a ML model based on the first CSI-RS pattern. In some cases, the operations of this step refer to, or may be performed by, circuitry for updating and/or code for updating as described with reference to FIG. 14.

Method 1200 then proceeds to step 1215 with generating, using the updated ML model, CSI for the channel frequency range based on measurements taken by the UE according to the first CSI-RS pattern. In some cases, the operations of this step refer to, or may be performed by, circuitry for generating and/or code for generating as described with reference to FIG. 14.

Method 1200 then proceeds to step 1220 with transmitting a report to the network entity indicating the CSI for the channel frequency range. In some cases, the operations of this step refer to, or may be performed by, circuitry for transmitting and/or code for transmitting as described with reference to FIG. 14.

In some aspects, updating the ML model based on the first CSI-RS pattern comprises training the ML model using measurements of CSI-RS transmitted according to the first CSI-RS pattern.

In some aspects, the method 1200 further includes training the ML model using measurements of CSI-RS transmitted according to the second CSI-RS pattern. In some cases, the operations of this step refer to, or may be performed by, circuitry for training and/or code for training as described with reference to FIG. 14.

In some aspects, the first CSI-RS pattern is associated with a cover code.

In some aspects, the method 1200 further includes measuring the CSI-RS by demultiplexing CSI-RS using the cover code. In some cases, the operations of this step refer to, or may be performed by, circuitry for measuring and/or code for measuring as described with reference to FIG. 14.

In some aspects, the cover code is one of a set of pre-configured cover codes, wherein each of the pre-configured cover codes is associated with a CSI-RS pattern.

In some aspects, the method 1200 further includes determining the cover code, based on: the first CSI-RS pattern; and the association of the first CSI-RS pattern with the cover code. In some cases, the operations of this step refer to, or may be performed by, circuitry for determining and/or code for determining as described with reference to FIG. 14.

In some aspects, the channel frequency range spans a number of RBs; and the first CSI-RS pattern comprises a non-uniformly spaced subset of the RBs.

In some aspects, the first CSI-RS pattern comprises one or more RBs on an edge of the channel frequency range.

In some aspects, the UE selects the first CSI-RS pattern from a plurality of possible CSI-RS patterns.

In some aspects, the method 1200 further includes transmitting, to the network entity, an indication that the UE selected the first CSI-RS pattern. In some cases, the operations of this step refer to, or may be performed by, circuitry for transmitting and/or code for transmitting as described with reference to FIG. 14.

In some aspects, the UE is configured with the plurality of possible CSI-RS patterns.

In some aspects, the UE is configured with a function for generating the plurality of possible CSI-RS patterns.

In some aspects, the indication comprises indices of frequency resources in the first CSI-RS pattern.

In some aspects, the signaling indicating at least the first CSI-RS pattern comprises a CSI-RS resource configuration.

In some aspects, the signaling indicates a seed value; and the UE generates the first CSI-RS pattern from a random permutation function using the seed value.

In some aspects, the signaling configures the first CSI-RS pattern and the second CSI-RS pattern via a CSI-RS resource set configuration.

In some aspects, updating the ML model comprises: performing a first channel estimation based on measurements taken of CSI-RS transmitted according to the second CSI-RS pattern in a first slot; performing a second channel estimation based on measurements taken of CSI-RS transmitted according to the first CSI-RS pattern in a second slot; and training the ML model based on the first channel estimation and the second channel estimation.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of A Network Entity

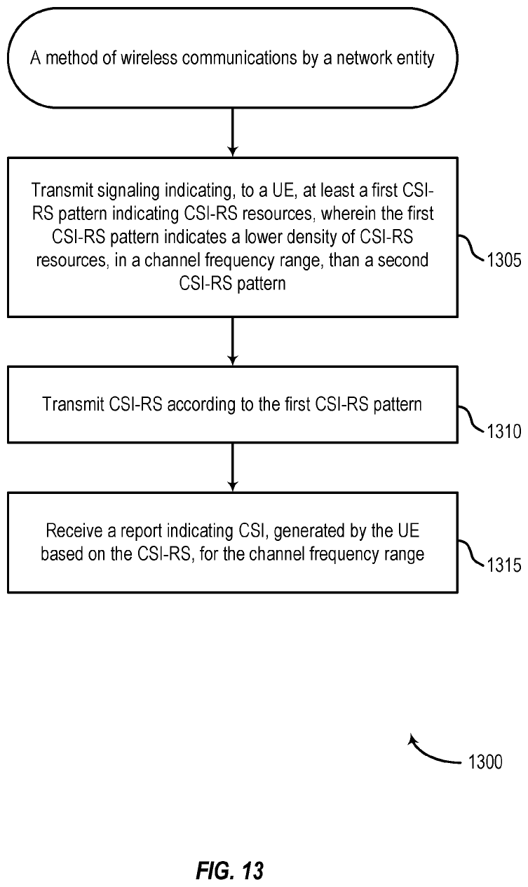

FIG. 13 shows an example of a method 1300 A method of wireless communications by a network entity by a network entity, such as BS 102 of FIGS. 1 and 3, or a disaggregated base station as discussed with respect to FIG. 2.

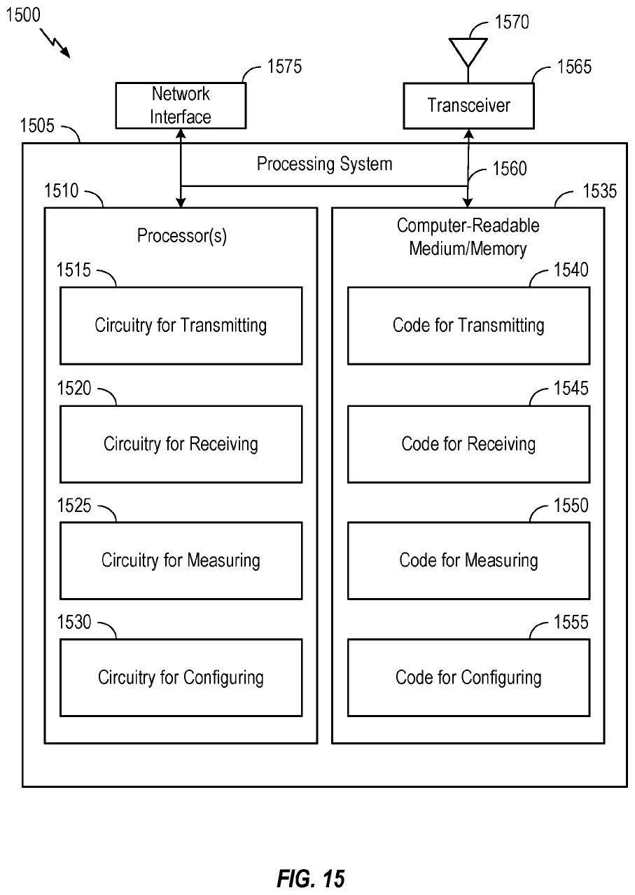

Method 1300 begins at step 1305 with transmitting signaling indicating, to a UE, at least a first CSI-RS pattern indicating CSI-RS resources, wherein the first CSI-RS pattern indicates a lower density of CSI-RS resources, in a channel frequency range, than a second CSI-RS pattern. In some cases, the operations of this step refer to, or may be performed by, circuitry for transmitting and/or code for transmitting as described with reference to FIG. 15.

Method 1300 then proceeds to step 1310 with transmitting CSI-RS according to the first CSI-RS pattern. In some cases, the operations of this step refer to, or may be performed by, circuitry for transmitting and/or code for transmitting as described with reference to FIG. 15.

Method 1300 then proceeds to step 1315 with receiving a report indicating CSI, generated by the UE based on the CSI-RS, for the channel frequency range. In some cases, the operations of this step refer to, or may be performed by, circuitry for receiving and/or code for receiving as described with reference to FIG. 15.

In some aspects, the first CSI-RS pattern is associated with a cover code.

In some aspects, the method 1300 further includes measuring the CSI-RS by demultiplexing CSI-RS using the cover code. In some cases, the operations of this step refer to, or may be performed by, circuitry for measuring and/or code for measuring as described with reference to FIG. 15.

In some aspects, the cover code is one of a set of pre-configured cover codes, wherein each of the pre-configured cover codes is associated with a CSI-RS pattern.

In some aspects, the channel frequency range spans a number of RBs; and the first CSI-RS pattern comprises a non-uniformly spaced subset of the RBs.

In some aspects, the first CSI-RS pattern comprises one or more RBs on an edge of the channel frequency range.

In some aspects, the method 1300 further includes configuring the UE with a plurality of possible CSI-RS patterns, including the first CSI-RS pattern. In some cases, the operations of this step refer to, or may be performed by, circuitry for configuring and/or code for configuring as described with reference to FIG. 15.

In some aspects, the method 1300 further includes receiving an indication that the UE has selected the first CSI-RS pattern from the plurality of possible CSI-RS patterns. In some cases, the operations of this step refer to, or may be performed by, circuitry for receiving and/or code for receiving as described with reference to FIG. 15.

In some aspects, configuring the UE with the plurality of possible CSI-RS patterns comprises configuring the UE with a function for generating the plurality of possible CSI-RS patterns.

In some aspects, the signaling indicating at least the first CSI-RS pattern comprises a CSI-RS resource configuration.

In some aspects, the signaling indicates a seed value; and the UE generates the first CSI-RS pattern from a random permutation function using the seed value.

In some aspects, the signaling configures the first CSI-RS pattern and the second CSI-RS pattern via a CSI-RS resource set configuration.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1486 (e.g., a transmitter and/or a receiver). The transceiver 1486 is configured to transmit and receive signals for the communications device 1400 via the antenna 1488, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1450 via a bus 1484. In certain aspects, the computer-readable medium/memory 1450 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1450 stores code (e.g., executable instructions), such as code for receiving 1455, code for updating 1460, code for generating 1465, code for transmitting 1470, code for training 1475, code for measuring 1480, and code for determining 1482. Processing of the code for receiving 1455, code for updating 1460, code for generating 1465, code for transmitting 1470, code for training 1475, code for measuring 1480, and code for determining 1482 may cause the communications device 1400 to perform the method 1200 described with respect to FIG. 12, or any aspect related to it.

The one or more processors 1410 include circuitry configured to implement (e.g., execute) the code stored in the computer-readable medium/memory 1450, including circuitry such as circuitry for receiving 1415, circuitry for updating 1420, circuitry for generating 1425, circuitry for transmitting 1430, circuitry for training 1435, circuitry for measuring 1440, and circuitry for determining 1445. Processing with circuitry for receiving 1415, circuitry for updating 1420, circuitry for generating 1425, circuitry for transmitting 1430, circuitry for training 1435, circuitry for measuring 1440, and circuitry for determining 1445 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1486 and the antenna 1488 of the communications device 1400 in FIG. 14. Means for receiving or obtaining may include transceivers 354 and/or antenna(s) 352 of the UE 104 illustrated in FIG. 3 and/or the transceiver 1486 and the antenna 1488 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1565 (e.g., a transmitter and/or a receiver) and/or a network interface 1575. The transceiver 1565 is configured to transmit and receive signals for the communications device 1500 via the antenna 1570, such as the various signals as described herein. The network interface 1575 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1535 stores code (e.g., executable instructions), such as code for transmitting 1540, code for receiving 1545, code for measuring 1550, and code for configuring 1555. Processing of the code for transmitting 1540, code for receiving 1545, code for measuring 1550, and code for configuring 1555 may cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry such as circuitry for transmitting 1515, circuitry for receiving 1520, circuitry for measuring 1525, and circuitry for configuring 1530. Processing with circuitry for transmitting 1515, circuitry for receiving 1520, circuitry for measuring 1525, and circuitry for configuring 1530 may cause the communications device 1500 to perform the method 1300 as described with respect to FIG. 13, or any aspect related to it.

Various components of the communications device 1500 may provide means for performing the method 1300 as described with respect to FIG. 13, or any aspect related to it. Means for transmitting, sending or outputting for transmission may include transceivers 332 and/or antenna(s) 334 of the BS 102 illustrated in FIG. 3 and/or the transceiver 1565 and the antenna 1570 of the communications device 1500 in FIG. 15. Means for receiving or obtaining may include transceivers 332 and/or antenna(s) 334 of the BS 102 illustrated in FIG. 3 and/or the transceiver 1565 and the antenna 1570 of the communications device 1500 in FIG. 15.

### Example Clauses

Implementation examples are described in the following numbered clauses:

Clause 1: A method of wireless communications by a UE, comprising: receiving signaling, from a network entity, indicating at least a first CSI-RS pattern indicating CSI-RS resources, wherein the first CSI-RS pattern indicates a lower density of CSI-RS resources in a channel frequency range, than a second CSI-RS pattern; updating a ML model based on the first CSI-RS pattern; generating, using the updated ML model, CSI for the channel frequency range based on measurements taken by the UE according to the first CSI-RS pattern; and transmitting a report to the network entity indicating the CSI for the channel frequency range.

Clause 2: The method of Clause 1, wherein updating the ML model based on the first CSI-RS pattern comprises training the ML model using measurements of CSI-RS transmitted according to the first CSI-RS pattern.

Clause 3: The method of Clause 2, further comprising: training the ML model using measurements of CSI-RS transmitted according to the second CSI-RS pattern.

Clause 4: The method of any one of Clauses 1-3, wherein: the first CSI-RS pattern is associated with a cover code; and the method further comprises measuring the CSI-RS by demultiplexing CSI-RS using the cover code.

Clause 5: The method of Clause 4, wherein the cover code is one of a set of pre-configured cover codes, wherein each of the pre-configured cover codes is associated with a CSI-RS pattern.

Clause 6: The method of Clause 4, further comprising: determining the cover code, based on: the first CSI-RS pattern; and the association of the first CSI-RS pattern with the cover code.

Clause 7: The method of any one of Clauses 1-6, wherein: the channel frequency range spans a number of RBs; and the first CSI-RS pattern comprises a non-uniformly spaced subset of the RBs.

Clause 8: The method of Clause 7, wherein the first CSI-RS pattern comprises one or more RBs on an edge of the channel frequency range.

Clause 9: The method of any one of Clauses 1-8, wherein: the UE selects the first CSI-RS pattern from a plurality of possible CSI-RS patterns; and the method further comprises transmitting, to the network entity, an indication that the UE selected the first CSI-RS pattern.

Clause 10: The method of Clause 9, wherein the UE is configured with the plurality of possible CSI-RS patterns.

Clause 11: The method of Clause 9, wherein the UE is configured with a function for generating the plurality of possible CSI-RS patterns.

Clause 12: The method of Clause 9, wherein the indication comprises indices of frequency resources in the first CSI-RS pattern.

Clause 13: The method of any one of Clauses 1-12, wherein the signaling indicating at least the first CSI-RS pattern comprises a CSI-RS resource configuration.

Clause 14: The method of Clause 13, wherein: the signaling indicates a seed value; and the UE generates the first CSI-RS pattern from a random permutation function using the seed value.

Clause 15: The method of any one of Clauses 1-14, wherein the signaling configures the first CSI-RS pattern and the second CSI-RS pattern via a CSI-RS resource set configuration.

Clause 16: The method of Clause 15, wherein updating the ML model comprises: performing a first channel estimation based on measurements taken of CSI-RS transmitted according to the second CSI-RS pattern in a first slot; performing a second channel estimation based on measurements taken of CSI-RS transmitted according to the first CSI-RS pattern in a second slot; and training the ML model based on the first channel estimation and the second channel estimation.

Clause 17: A method of wireless communications by a network entity, comprising: transmitting signaling indicating, to a UE, at least a first CSI-RS pattern indicating CSI-RS resources, wherein the first CSI-RS pattern indicates a lower density of CSI-RS resources, in a channel frequency range, than a second CSI-RS pattern; transmitting CSI-RS according to the first CSI-RS pattern; and receiving a report indicating CSI, generated by the UE based on the CSI-RS, for the channel frequency range.

Clause 18: The method of Clause 17, wherein: the first CSI-RS pattern is associated with a cover code; and the method further comprises measuring the CSI-RS by demultiplexing CSI-RS using the cover code.

Clause 19: The method of Clause 18, wherein the cover code is one of a set of pre-configured cover codes, wherein each of the pre-configured cover codes is associated with a CSI-RS pattern.

Clause 20: The method of any one of Clauses 17-19, wherein: the channel frequency range spans a number of RBs; and the first CSI-RS pattern comprises a non-uniformly spaced subset of the RBs.

Clause 21: The method of Clause 20, wherein the first CSI-RS pattern comprises one or more RBs on an edge of the channel frequency range.

Clause 22: The method of any one of Clauses 17-21, further comprising: configuring the UE with a plurality of possible CSI-RS patterns, including the first CSI-RS pattern; and receiving an indication that the UE has selected the first CSI-RS pattern from the plurality of possible CSI-RS patterns.

Clause 23: The method of Clause 22, wherein configuring the UE with the plurality of possible CSI-RS patterns comprises configuring the UE with a function for generating the plurality of possible CSI-RS patterns.

Clause 24: The method of any one of Clauses 17-23, wherein the signaling indicating at least the first CSI-RS pattern comprises a CSI-RS resource configuration.

Clause 25: The method of Clause 24, wherein: the signaling indicates a seed value; and the UE generates the first CSI-RS pattern from a random permutation function using the seed value.

Clause 26: The method of any one of Clauses 17-25, wherein the signaling configures the first CSI-RS pattern and the second CSI-RS pattern via a CSI-RS resource set configuration.

Clause 27: An apparatus, comprising: a memory comprising executable instructions; and a processor configured to execute the executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by a processor of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communications by a user equipment (UE), comprising:
receiving signaling, from a network entity, indicating at least a first channel state information (CSI) reference signal (CSI-RS) pattern indicating CSI-RS resources,
wherein the first CSI-RS pattern indicates a lower density of CSI-RS resources in a channel frequency range, than a second CSI-RS pattern;
updating a machine learning (ML) model based on the first CSI-RS pattern;
generating, using the updated ML model, CSI for the channel frequency range based on measurements taken by the UE according to the first CSI-RS pattern; and
transmitting a report to the network entity indicating the CSI for the channel frequency range.

2. The method of claim 1, wherein updating the ML model based on the first CSI-RS pattern comprises training the ML model using measurements of CSI-RS transmitted according to the first CSI-RS pattern.

3. The method of claim 2, further comprising training the ML model using measurements of CSI-RS transmitted according to the second CSI-RS pattern.

4. The method of claim 1, wherein:
the first CSI-RS pattern is associated with a cover code; and
the method further comprises measuring the CSI-RS by demultiplexing CSI-RS using the cover code.

5. The method of claim 4, wherein the cover code is one of a set of pre-configured cover codes, wherein each of the pre-configured cover codes is associated with a CSI-RS pattern.

6. The method of claim 4, further comprising determining the cover code, based on:
the first CSI-RS pattern; and
the association of the first CSI-RS pattern with the cover code.

7. The method of claim 1, wherein:
the channel frequency range spans a plurality of resource blocks (RBs); and
the first CSI-RS pattern comprises a non-uniformly spaced subset of the plurality of RBs.

8. The method of claim 7, wherein the first CSI-RS pattern comprises one or more RBs on an edge of the channel frequency range.

9. The method of claim 1, wherein:
the UE selects the first CSI-RS pattern from a plurality of possible CSI-RS patterns; and
the method further comprises transmitting, to the network entity, an indication that the UE selected the first CSI-RS pattern.

10. The method of claim 9, wherein the UE is configured with the plurality of possible CSI-RS patterns.

11. The method of claim 9, wherein the UE is configured with a function for generating the plurality of possible CSI-RS patterns.

12. The method of claim 9, wherein the indication comprises indices of frequency resources in the first CSI-RS pattern.

13. The method of claim 1, wherein the signaling indicating at least the first CSI-RS pattern comprises a CSI-RS resource configuration.

14. The method of claim 13, wherein:
the signaling indicates a seed value; and
the UE generates the first CSI-RS pattern from a random permutation function using the seed value.

15. The method of claim 1, wherein the signaling configures the first CSI-RS pattern and the second CSI-RS pattern via a CSI-RS resource set configuration.

16. The method of claim 15, wherein updating the ML model comprises:
performing a first channel estimation based on measurements taken of CSI-RS transmitted according to the second CSI-RS pattern in a first slot;
performing a second channel estimation based on measurements taken of CSI-RS transmitted according to the first CSI-RS pattern in a second slot; and
training the ML model based on the first channel estimation and the second channel estimation.

17. A method of wireless communications by a network entity, comprising:
transmitting signaling indicating, to a user equipment (UE), at least a first channel state information (CSI) reference signal (CSI-RS) pattern indicating CSI-RS resources, wherein the first CSI-RS pattern indicates a lower density of CSI-RS resources, in a channel frequency range, than a second CSI-RS pattern;
transmitting CSI-RS according to the first CSI-RS pattern; and
receiving a report indicating CSI, generated by the UE based on the CSI-RS, for the channel frequency range.

18. The method of claim 17, wherein:
the first CSI-RS pattern is associated with a cover code; and
the method further comprises measuring the CSI-RS by demultiplexing CSI-RS using the cover code.

19. The method of claim 18, wherein the cover code is one of a set of pre-configured cover codes, wherein each of the pre-configured cover codes is associated with a CSI-RS pattern.

20. The method of claim 17, wherein:
the channel frequency range spans a plurality of resource blocks (RBs); and
the first CSI-RS pattern comprises a non-uniformly spaced subset of the plurality of RBs.

21. The method of claim 20, wherein the first CSI-RS pattern comprises one or more RBs on an edge of the channel frequency range.

22. The method of claim 17, further comprising:
configuring the UE with a plurality of possible CSI-RS patterns, including the first CSI-RS pattern; and
receiving an indication that the UE has selected the first CSI-RS pattern from the plurality of possible CSI-RS patterns.

23. The method of claim 22, wherein configuring the UE with the plurality of possible CSI-RS patterns comprises configuring the UE with a function for generating the plurality of possible CSI-RS patterns.

24. The method of claim 17, wherein the signaling indicating at least the first CSI-RS pattern comprises a CSI-RS resource configuration.

25. The method of claim 24, wherein:
the signaling indicates a seed value; and
the UE generates the first CSI-RS pattern from a random permutation function using the seed value.

26. The method of claim 17, wherein the signaling configures the first CSI-RS pattern and the second CSI-RS pattern via a CSI-RS resource set configuration.

27. An apparatus, comprising: a memory comprising executable instructions; and a processor configured to execute the executable instructions and cause the apparatus to:
receive signaling, from a network entity, indicating at least a first channel state information (CSI) reference signal (CSI-RS) pattern indicating CSI-RS resources,
wherein the first CSI-RS pattern indicates a lower density of CSI-RS resources in a channel frequency range, than a second CSI-RS pattern;
update a machine learning (ML) model based on the first CSI-RS pattern;
generate, using the updated ML model, CSI for the channel frequency range based on measurements taken by the apparatus according to the first CSI-RS pattern; and
transmit a report to the network entity indicating the CSI for the channel frequency range.

28. An apparatus, comprising: a memory comprising executable instructions; and a processor configured to execute the executable instructions and cause the apparatus to:
transmit signaling indicating, to a user equipment (UE), at least a first channel state information (CSI) reference signal (CSI-RS) pattern indicating CSI-RS resources, wherein the first CSI-RS pattern indicates a lower density of CSI-RS resources, in a channel frequency range, than a second CSI-RS pattern;
transmit CSI-RS according to the first CSI-RS pattern; and
receive a report indicating CSI, generated by the UE based on the CSI-RS, for the channel frequency range.

29-30. (canceled)
